(19) United States
(12) Patent Application Publication
(10) Pub. No.: US 2015/0092089 A1
(43) Pub. Date: Apr. 2, 2015

(54) System And Method For Under Sampled Image Enhancement

(71) Applicant: Broadcom Corporation, Irvine, CA (US)

(72) Inventors: Ilia Vitsnudel, Even Yehuda (IL); Noam Sorek, Zichron Yacoov (IL)

(73) Assignee: Broadcom Corporation, Irvine, CA (US)

(21) Appl. No.: 14/053,837

(22) Filed: Oct. 15, 2013

Related U.S. Application Data
(60) Provisional application No. 61/883,787, filed on Sep. 27, 2013.

(51) Int. Cl. G06T 5/00; G06T 5/50; H04N 5/238

(52) U.S. Cl. CPC G06T 5/002; H04N 5/238; G06T 5/50; G06T 2207/10004; G06T 2207/20024; G06T 2207/20182; G06T 2207/20216; G06T 2200/12
USPC 348/242; 348/241

(57) ABSTRACT

A system and method are provided for acquiring a first image and a second image, where the first image has a higher optical density than the second image, and combining the first image with the second image to generate an output image with reduced aliasing artifacts.

### TECHNICAL FIELD

This disclosure relates to a system and method for under sampled image enhancement.

### BACKGROUND

Manufacturing improvements have led to the generation of imaging sensors that provide continuously increasing resolution to cameras. However, imaging sensors are paired with optical systems that focus light onto the sensors. Often though, cameras under sample the image, by using optical systems with higher optical resolution than the imaging sensor, and as a result aliasing artifacts may appear within the image in areas where the image data contains repetitive high frequency content. These aliasing artifacts distort the image and are distracting to users.

### BRIEF DESCRIPTION OF THE DRAWINGS

FIG. 1 is a block diagram illustrating a system for image enhancement.

FIG. 2 is a block diagram of another system for image enhancement.

FIG. 3 is a flow chart illustrating a method for image enhancement.

FIG. 4 is a flow chart for another method of image enhancement.

FIG. 5 is a flow chart of a method for combining images for image enhancement.

FIG. 6 is a diagram illustrating the combination of images for image enhancement.

FIG. 7 is a flow chart illustrating a method for combining images for image enhancement.

FIG. 8 is a diagram illustrating the combining of images for image enhancement.

### DETAILED DESCRIPTION

In any digital system, in order to reconstruct the signal, the sampling frequency may preferably match the signal maximum frequency, namely the Nyquist frequency. In some imaging systems, where the camera sensor samples the incoming signal from the optics, the pixel density may preferably be roughly twice the optical bandwidth. Many cameras under sample the image resulting in some aliasing artifacts within the image in areas where the image data contains repetitive high frequency content. In most areas better resolution is received as a tradeoff for the aliasing. The aliasing artifacts in the color domain are typically more severe than the ones in the luminance channel, as the color sampling density is lower. The techniques described herein provide a way to use higher optical density images with lower resolution sensors, while limiting the aliasing artifacts in reconstructed images. In some implementations, two images are combined, one with higher optical density (e.g. in-focus) that includes aliasing, and the other with lower optical density (e.g. a bit out of focus) without aliasing. The combination of the images could take the information, in areas without strong aliasing, from the focused image, and the areas with aliasing from the unfocused image. In some implementations, the color information could come from the unfocused image and the luminance information from the focused image. In some implementations the two images can be combined mathematically to resolve the aliasing.

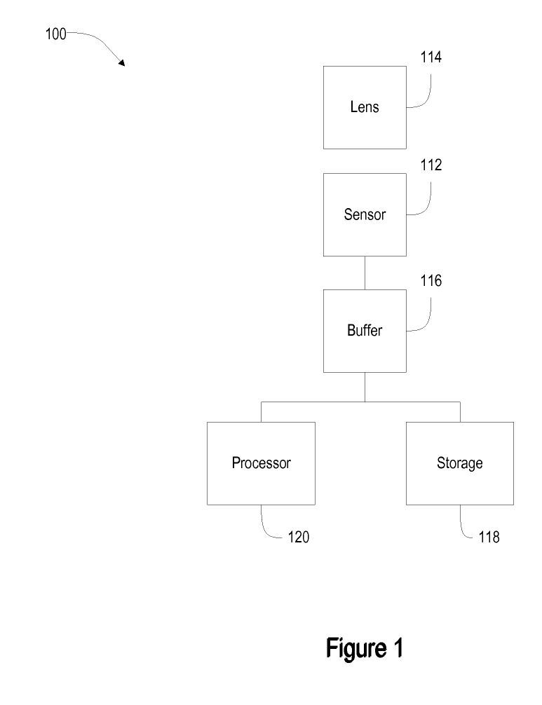

FIG. 1 is a block diagram of a system for image enhancement. The system 100 includes a processor 120 and a sensor 112. The sensor 112 is configured to view an object through the lens assembly 114. The sensor 112 may be an imaging sensor for example, a CMOS imager, a CCD imager, or other known imaging device. The sensor 112 may be comprised of a plurality of sensing elements, such as pixels, that collect image data. The sensor 112 may communicate the image data to a buffer 116. The buffer 116 may communicate the image data to storage 118 or directly to a processor 120. The sensor 112 may capture still images. For example, the sensor 112 may capture multiple still images successively and, further, the shutter may be actuated between each image. The sensor 112 may capture video where images are captured continuously and, for example, the image data is streamed through the buffer 116 as the sensor 112 continues acquisition of subsequent images.

The processor 120 may be configured to process the images acquired by the sensor 112. For example, the processor 120 may be configured to apply filters to the image data, compare image data across images, or manipulate image data, in addition to other image processing functionality. The manipulation of the image data may include generating templates from the images, forming geometric corrections, registering images with regard to one another, as well as other image transformations. The processor 120 may receive the image data directly from the image buffer 116 or may access previously stored data from the storage 118. The storage 118 may be a random access memory, a static memory, a hard disk drive, or other storage device.

The processor 120 may be configured to adjust image acquisition characteristics. For example, the processor 120 may be configured to adjust the electronic exposure, pixel gain, and other electronic characteristics of the sensor 112. In addition, the processor 120 may be configured to communicate with the lens assembly 114 to adjust an aperture or f-stop of the lens assembly, focus of the lens assembly, magnification of the lens assembly, or other optical characteristics affecting the acquisition of the images. In some implementations, the processor 120 may be configured to identify characteristics of the aliasing artifacts within the image data. The characteristics of the aliasing artifacts may include size, shape, frequency, contrast, location, etc. Further, the processor 120 may adjust any of the electronic characteristics of the sensor or optical characteristics of the lens assembly affecting acquisition in response to the aliasing artifacts. For example, the adjustment may be based on a calculation including one or more aliasing artifact characteristics and/or electronic sensor characteristics, and/or lens assembly optical characteristics. In this regard, the processor may calculate an amount of optical parameter difference between the first image and the second image based on characteristics of the aliasing artifact.

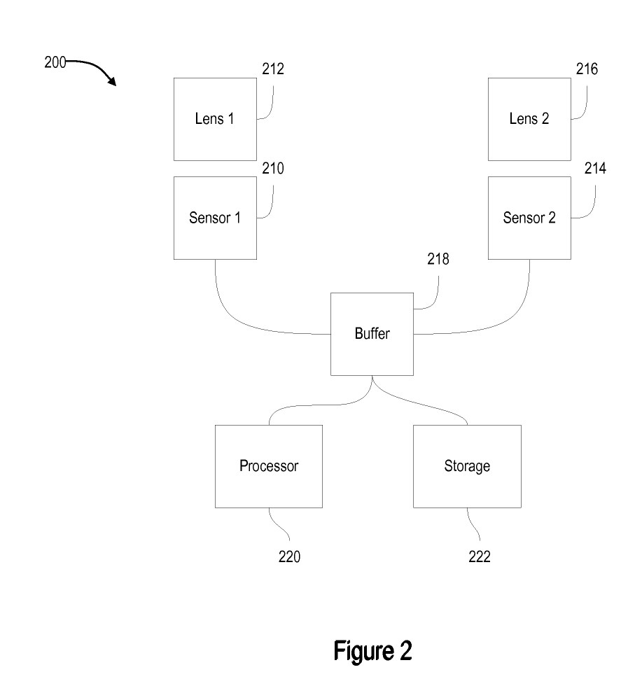

FIG. 2 is a block diagram of another system for image enhancement. The system 200 includes a first sensor 210, a second sensor 214, and a processor 220. The first sensor 210 is configured to view an object through a first lens assembly 212. The second sensor 214 is configured to view an object through a second lens assembly 216. The first sensor 210 and the second sensor 214 may be an imaging sensor for example, a CMOS imager, a CCD imager, or other known imaging device. The first sensor 210 and the second sensor 214 may be comprised of a plurality of sensing elements. The first sensor 210 may generate images with a higher optical density than images from the second sensor 214. The first sensor 210 may have more pixels than the second sensor 214. In some implementations, the first sensor 210 may have a smaller pixel size than the second sensor 214. Further, electronic settings of the first sensor 210 may be different than the second sensor 214. For example, the exposure time, pixel gain, and other settings may be different from the first sensor 210 to the second sensor 214.

The processor 220 may be configured to adjust image acquisition characteristics of the first sensor 210 and the second sensor 214. For example, the processor 220 may be configured to adjust, electronic exposure, pixel gain, and other electronic characteristics. In addition, the processor 220 may be configured to communicate with the lens assembly 212 to adjust an aperture or f-stop of the lens assembly, focus of the lens assembly, magnification of the lens assembly, or other optical characteristics affecting the acquisition of the images. Similarly, the processor 220 may be configured to communicate with the lens assembly 216 to adjust an aperture or f-stop of the lens assembly, focus of the lens assembly, magnification of the lens assembly, or other optical characteristics affecting the acquisition of the images. In this manner, the first lens assembly 212 may be configured to have different optical characteristics than the second lens assembly 216. For example, the first lens assembly 212 may have a higher optical resolution and/or a different focal length than the second lens assembly 216. Further, the optical parameters may be changed between the first lens assembly 212 and second lens assembly 216. In some implementations, the first lens assembly 212 may have a different focus, F-stop, shutter speed, or any combination thereof relative to the second lens assembly 216. In addition, various combinations of optical and electrical parameters may be used between the first sensor 210 and first lens assembly 212 relative to the second sensor 214 and second lens assembly 216.

In some implementations, the processor 220 may be configured to identify characteristics of the aliasing artifacts within the image data. The characteristics of the aliasing artifacts may include size, shape, frequency, contrast, location, etc. Further, the processor 220 may adjust any of the electronic characteristics of one or both of the sensors and/or optical characteristics of one or both of lens assemblies affecting acquisition in response to the aliasing artifacts. For example, the adjustment may be based on a calculation including one or more aliasing artifact characteristics and/or electronic sensor characteristics, and/or lens assembly optical characteristics.

The first sensor 210 and the second sensor 214 may communicate the image data to a buffer 218. The buffer 218 may communicate the image data to a storage 222 or directly to a processor 220. The first sensor 210 and/or the second sensor 214 may capture still images. For example, the sensors may capture multiple still images successively and, further, the shutter may actuate between each image. The first sensor 210 and/or the second sensor 214 may capture video where images are captured continuously and the image data is streamed through the buffer 218 as the sensor continues acquisition of subsequent images.

The first sensor 210 may be synchronized with the second sensor 214 such that the first sensor 210 and the second sensor 214 each acquire an image simultaneously. Further, the first lens assembly 212 and the second lens assembly 216 may be configured such that the first sensor 210 and the second sensor 214 have approximately the same field of view. In some implementations, the first sensor 210 and the second sensor 214 may be in optical communication with an optical element (e.g. a beam splitter) such that the optical path of the first sensor 210 and the optical path of the second sensor 214 are partially shared. Accordingly, the light may be captured by a single lens assembly and distributed to the first sensor 210 and the second sensor 214 simultaneously.

The processor 220 may be configured to process the images acquired by the first sensor 210 and the second sensor 214. For example, the processor 220 may be configured to apply filters to the image data, compare image data across images, or manipulate image data, in addition to other image processing functionality. The manipulation of the image data may include generating templates from the images, forming geometric corrections, registering images with regard to one another, as well as other image transformations. The processor 220 may receive the image data directly from the image buffer 218 or may access previously stored data from the storage 222. The storage 222 may be a random access memory, a static memory, a hard disk drive, or other storage device.

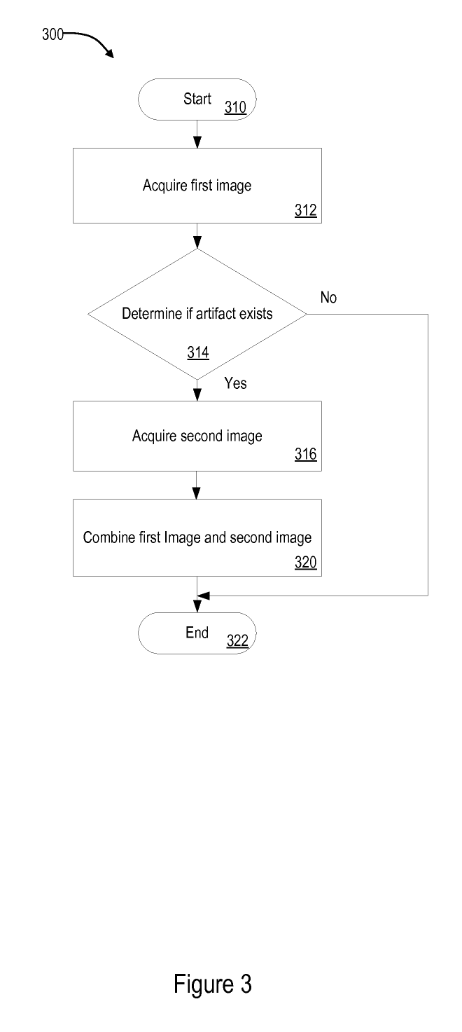

FIG. 3 is a flow chart illustrating a method for image enhancement. The method 300 may be initialized as part of a larger application, such as, a particular camera acquisition mode (310). The system may acquire a first image (312). The system may analyze the first image to determine if an aliasing artifact exists (314). Various image processing techniques may be used to determine if an artifact exists. For example, various edge detection or frequency analysis algorithms may be employed for artifact detection. If no aliasing artifact exists, the method may be completed and the first acquired image may be used as the output image (322). If an aliasing artifact does exist, a second image may be acquired (316). The second image may be an image with a lower optical density than the first acquired image. Examples of these techniques are described in more detail throughout this application.

In some implementations, the second image may be acquired using the same sensor while changing the image acquisition parameters. The processor may be configured to adjust image acquisition parameters, such as, electronic sensor characteristics and/or optical lens assembly characteristics. For example, the processor may adjust electronic exposure, pixel gain, and other electronic characteristics. In addition, the processor may be configured to communicate with the lens assembly to adjust an aperture or f-stop of the lens assembly, focus of the lens assembly, magnification of the lens assembly, shutter speed or other optical characteristics affecting the acquisition of the images. In one example, a slower shutter speed may be used to obtain a second image that is less focused than the first image. In this example, the signal to noise ratio of the second image may be significantly increased over the first image and at the same time the second image may be more blurred, for example due to inherent hand shaking.

In some implementations, the processor may be configured to identify characteristics of the aliasing artifacts within the image data. The characteristics of the aliasing artifacts may include size, shape, frequency, contrast, location, etc. Further, the processor may adjust any of the electronic characteristics of the sensor or optical characteristics of the lens assembly affecting acquisition in response to the aliasing artifacts. For example, the adjustment may be based on a calculation including one or more aliasing artifact characteristics and/or electronic sensor characteristics, and/or lens assembly optical characteristics.

In some implementations, the second image may be acquired using a second sensor that is configured with different image acquisition parameters than the first sensor that acquired the first image. The first sensor may have a different resolution than the second sensor. For example, the first sensor may have a higher resolution than the second sensor. In some implementations, the first camera may have a greater number of pixels than the second camera, in other implementations; the first sensor may have a smaller pixel size than the second sensor. In some implementations, the optical characteristics of the first lens may be different than the optical characteristics of the second lens. For example, the first lens may have a higher optical resolution than the second lens. Further, the optical parameters may be changed between the first lens and second lens. For example, the first lens may have a different focus, F-stop, shutter speed, or any combination thereof relative to the second lens. In addition, various combinations of optical and electrical parameters may be used between the first sensor and first lens relative to the second sensor and second lens. Further, in some implementations, multiple images may be acquired while adjusting acquisition parameters until the aliasing artifacts in the second image are reduced below a defined level.

The system may then combine the first image and the second image to produce an output image (320). The images may be combined based on various factors including, for example, region and/or image component. The output image may then be used by the application program (322). While the methods herein are described with regard to the combination of two images, it can be understood from this disclosure that more than two images may be combined. In some examples, each image may have different optical densities that may be obtained by acquiring each of the two or more images with one or more different acquisition characteristics, for each image, as described throughout this applications. Further, all or portions of the two or more of the images may be combined according to various mathematical relationships as also discussed throughout this application.

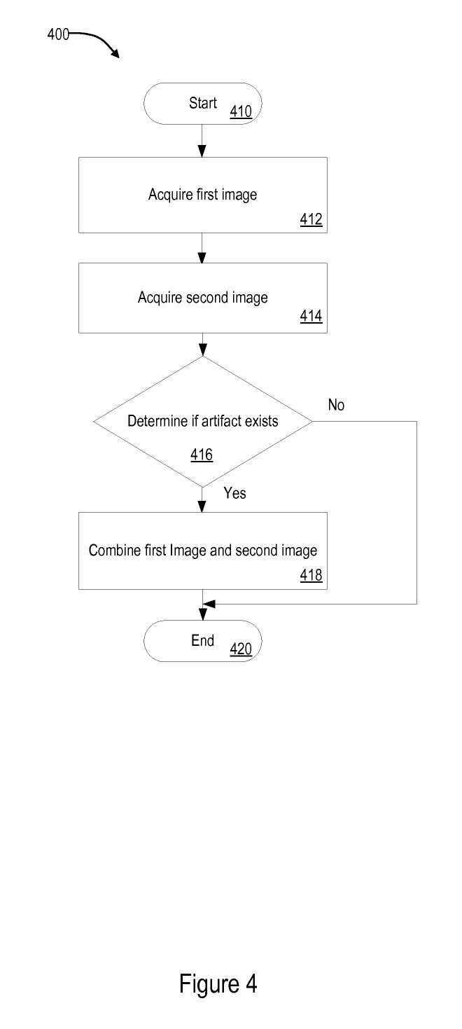

FIG. 4 is a flow chart illustrating a method for image enhancement. The method 400 may be initialized as part of a larger application for example, a particular camera acquisition mode (410). The system may acquire a first image (412). A second image may then be acquired (414). The second image may be an image with a lower optical density then the first acquired image. The second image may be acquired using the same sensor while changing the image acquisition parameters, or the second image may be acquired using a second sensor that is configured with acquisition characteristics different than the first sensor that acquired the first image. Various single and multiple camera examples are discussed throughout this application and are equally applicable to this method.

The system may analyze the first image to determine if an artifact exists (416). Various image processing techniques may be used to determine if an artifact exists. For example, various edge detection or frequency analysis algorithms may be employed for artifact detection. The system may compare the first image with the second image to determine if an artifact exists. If no artifact exists, the system may use the first image as the output image ending the method (422). If aliasing artifacts exist, the system may then combine the first image and the second image to produce an output image (420). The output image may then be used by the application program (422).

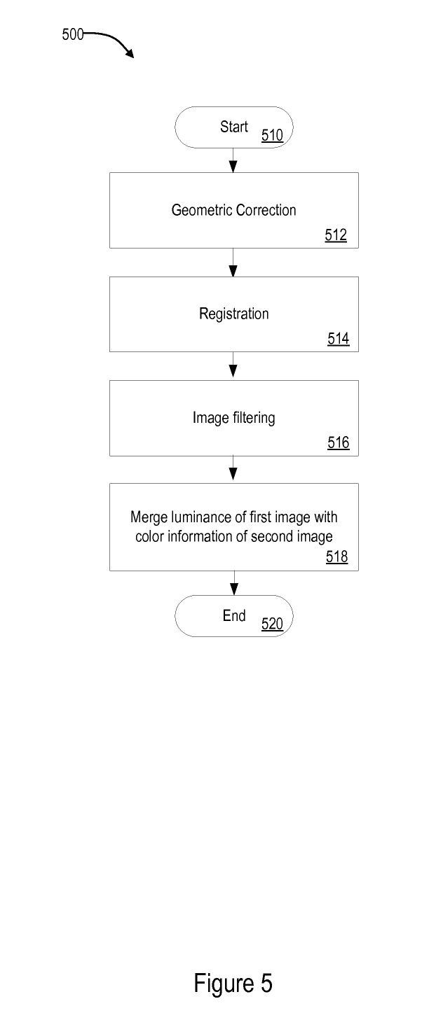

FIG. 5 is a flow chart of a method for combining images. The method 500 may begin as part of a larger method, for example those methods discussed in FIGS. 3 and 4 (510). The system may geometrically correct a first image relative to a second image (512). The first image may be distorted geometrically relative to the second image due to the first image being acquired using a different sensor than the second image. Accordingly, misalignment between the cameras may cause a geometric distortion between the first image and the second image. Geometric distortion may also be caused by one image being taken with a different focus than the second image. Each image and focus may cause a magnification change or other slight changes in the image geometry. As such, the geometric correction may be applied for any of the various optical parameter changes noted elsewhere in this application, for example, focus, F-stop, shutter speed, optical resolution, etc. The first image may also be registered relative to the second image (514). Registration between images may be necessary, for example, if the second image is taken subsequent to the first image and some time may have elapsed between the first image and second image. When time has elapsed between images, the objects in the image may have moved from one location to another. Alternatively, environmental conditions such as the location or orientation of the camera may also change thereby making registration of the first image relative to the second image beneficial.

At least one of the images may be filtered (516). The filtering may be one of many of a variety of filters, for example, a smoothing filter such as a Gaussian filter, a low pass filter, or other smoothing technique. The first image may be filtered, the second image may be filtered, or both of the images may be filtered. The system may then merge the first image with the second image (518). In one implementation, the luminance of the first image may be merged with the color information of the second image. In one example, the color information of the first image may be replaced with the color information of the second image. Alternatively, in some implementations, new values of the color information for each pixel may be calculated based on a function of the value of the first image and the value of the second image. Further, the merging could occur in one or more spaces. For example, the merging could occur in the luminance space, the chromance space, or in particular colors, such as one of R, G, or B, in RGB space, or Y, U, or V, in YUV space. The system may create an output image based on the merging of the first image and second image which may then be provided to various other methods (520).

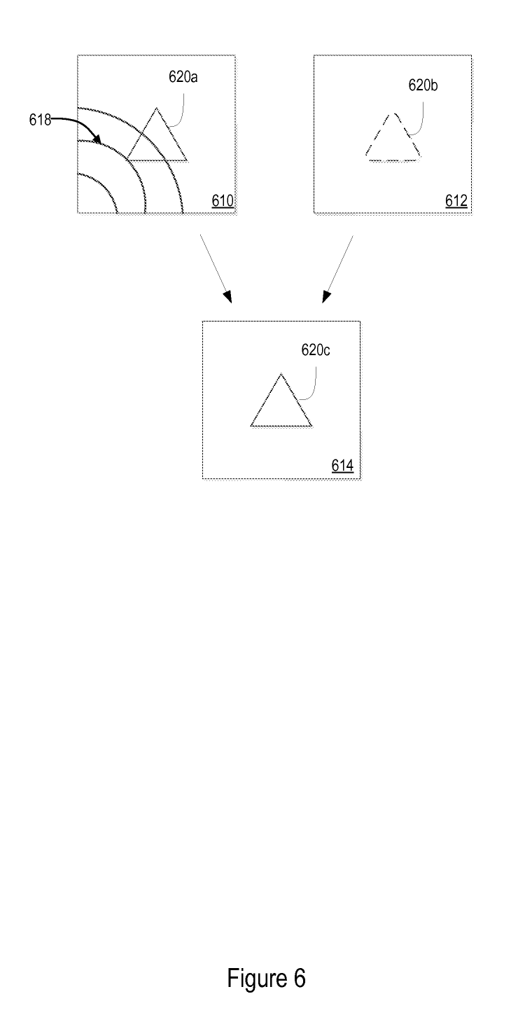

FIG. 6 is a diagram illustrating the combining of the first and second image. The first image 610 may have a higher optical density than the second image 612. The higher optical density of the first image 610 with regard to the second image 612 may be due to acquisition by different sensors, or acquisition using different acquisition parameters as described elsewhere in this application. The first image 610 includes an object 620a which may be in sharp focus. In addition, the first image 610 may include aliasing artifacts 618. The aliasing artifacts 618 may, for example, be a moiré fringe pattern. Due to the lower optical density of the second image 612 relative to the first image 610, the aliasing artifact 618 may be reduced and/or eliminated from the second image 612. As such, the second image 612 may be a closer representation to the actual field of view in some respects due to the removal of the aliasing artifacts 618. However, certain differences may still exist between the images. For example, if the second image 612 is out of focus with respect to the first image 610, the object 620b in the second image 612 may be less sharp or somewhat blurred. Accordingly, certain aspects of both the first and the second image may be desirable. In some instances, the aliasing artifact 618 may only be present in the color information of the image. Accordingly, the luminance information of the first image 610 may be combined with the color information from the second image 612 to generate an enhanced output image 614 that has improved characteristics over both the first image 610 and the second image 612 individually. For example, the output image 614 may have the aliasing artifacts 618 reduced and/or removed, as well as, a focused image as represented by object 620c.

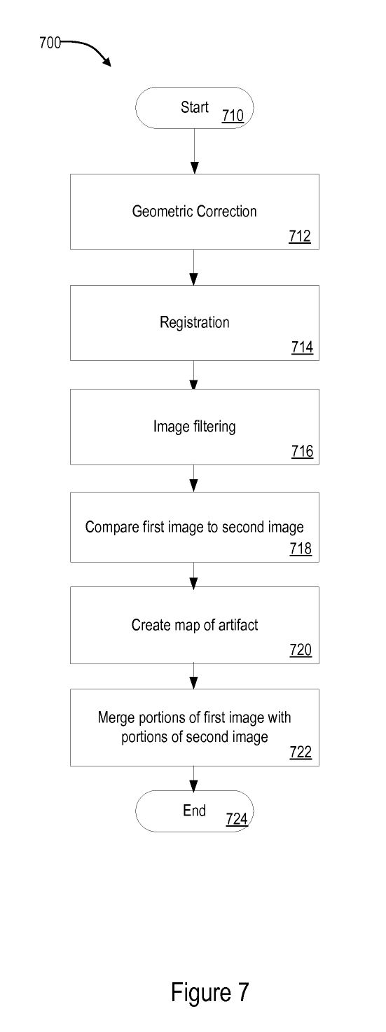

FIG. 7 is a flow chart of a method for combining images. The method 700 may begin as part of a larger method, for example those methods discussed in FIGS. 3 and 4 (710). The system may geometrically correct a first image relative to a second image (712). The first image may be distorted geometrically relative to the second image due to the first image being acquired using a different sensor than the second image. Accordingly, misalignment between the cameras may cause a geometric distortion between the first image and the second image. Geometric distortion may also be caused by one image being taken with a different focus than the second image. Each image and focus may cause a magnification change or other slight changes in the image geometry. As such, the geometric correction may be applied for any of the various optical parameter changes noted elsewhere in this application, for example, focus, F-stop, shutter speed, optical resolution, etc. The first image may also be registered relative to the second image (714).

Registration between images may be necessary. For example, if the second image is taken subsequent to the first image, then some time may have elapsed between the first image and second image. If time has elapsed between the images, objects in the images may have moved from one location to another. Further, environmental conditions such as the location or orientation of the camera may also change thereby making registration of the first image relative to the second image beneficial. At least one of the images may be filtered (716). The filtering may be one of many of a variety of filters, for example, a smoothing filter such as a Gaussian filter, a low pass filter, or other smoothing technique. The first image may be filtered, the second image may be filtered, or both of the images may be filtered.

The first image may be compared to the second image (718). For example, a difference between the first image and the second image may be calculated. A frequency analysis or various filtering techniques may then be applied to the difference image to identify portions of the difference image that correspond to the aliasing artifacts. A map may then be created of the aliasing artifacts (720). The system may merge portions of the first image with portions of the second image in areas defined by the map of the aliasing artifacts (722).

In one implementation, the luminance of the first image may be merged with the color information of the second image in response to the map. In one example, the color information of the first image may be replaced with the color information of the second image according to the map of the aliasing artifacts. Alternatively, in some implementations, new values of the color information for each pixel may be calculated based on a function of the value of the first image and the value of the second image according to the map of the aliasing artifacts. Further, the merging could occur in one or more spaces. For example, the merging could occur in the luminance space, the chromance space, or in particular colors, such as one of R, G, or B, in RGB space, or Y, U, or V, in YUV space. The system may create an output image based on the merging of the first image and second image which may then be provided to various other methods (724).

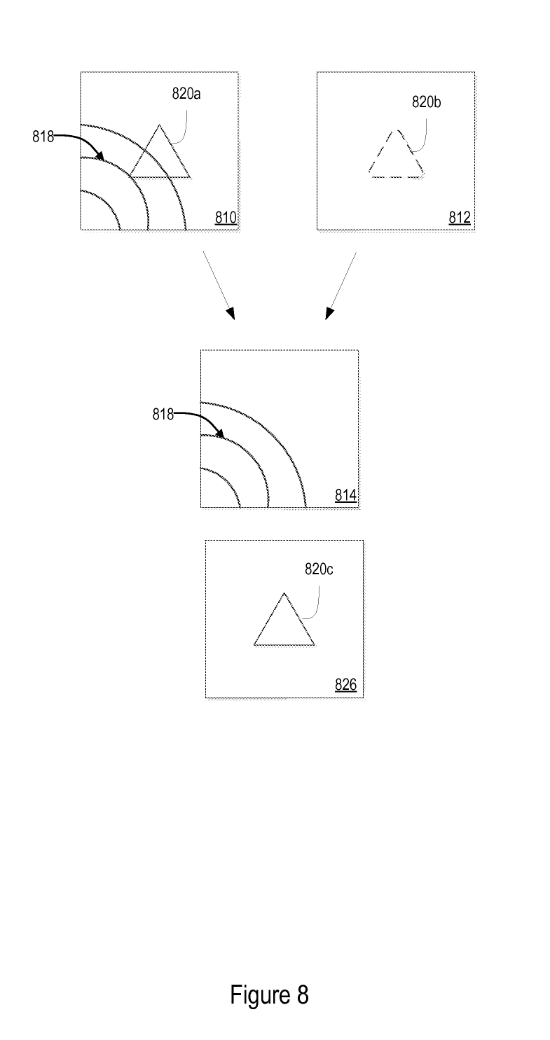

FIG. 8 is a diagram illustrating the combining of the first and second image. The first image 810 may have a higher optical density than the second image 812. The higher optical density of the first image 810 with regard to the second image 812 may be due to acquisition by different sensors, or acquisition using different acquisition parameters as described elsewhere in this application. The first image 810 includes an object 820a which may be in sharp focus. In addition, the first image 810 may include aliasing artifacts 818. The alias artifacts 818 may, for example, be a moiré fringe pattern. Due to the lower optical density of the second image 812 relative to the first image 810, the aliasing artifact 818 may be reduced and/or eliminated from the second image 812. As such, the second image 812 may be a closer representation to the actual field of view in some respects due to the removal of the aliasing artifacts 818. However, certain differences may still exist between the images. For example, if the second image 812 is out of focus with respect to the first image 810, the object 820b in the second image 812 may be less sharp than object 820a. Accordingly, certain aspects of both the first and the second image may be desirable.

A template 814 may be generated that provides a map the of aliasing artifacts 818. In one example, the first image 810 may be compared to the second image 812 to generate a difference between the images. A frequency analysis or various filtering techniques may then be applied to the difference image to identify portions of the difference image that correspond to the aliasing artifacts.

Portions of the second image 812 may then be merged with the first image 810 based on the template 814 to reduce or eliminate the aliasing artifacts 818. In some instances, the aliasing artifacts 818 may only be present in the color information of the image. Accordingly, the luminance information of the first image 810 may be combined with the color information from the second image 812 based on the template 816 to generate an enhanced output image 826 that has improved characteristics over both the first image 810 and the second image 812 individually. For example, the output image 826 may have the aliasing artifacts 818 reduced and/or removed, as well as, a focused image as represented by object 820c.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A system for enhancing images, the system comprising:
a sensor; and
a processor in communication with the sensor to receive a plurality of images, the processor being operable to control acquisition parameters of a first image relative to a second image such that the first image has a higher optical density than the second image, the processor being configured to combine the first image and the second image to produce an output image with reduced aliasing artifacts relative to the first image.

2. The system of claim 1, further comprising a lens assembly in optical communication with the sensor, the lens assembly being in communication with the processor, the processor being configured to change optical parameters of the lens assembly between acquisition of the first image and acquisition of the second image.

3. The system of claim 2, wherein the processor is configured to change a focus of the lens assembly between the acquisition of the first image and the acquisition of the second image.

4. The system of claim 2, wherein the processor is configured to change a f-stop of the lens assembly between the acquisition of the first image and the acquisition of the second image.

5. The system of claim 2, wherein the processor is configured to change a shutter speed of the lens assembly between the acquisition of the first image and the acquisition of the second image.

6. A method for enhancing images, the method comprising:
acquiring a first image;
acquiring a second image, the first image having a higher optical density than the second image; and
combining the first image with the second image to generate an output image with reduced aliasing artifacts.

7. The method according to claim 6, wherein the output image is generated by combining a luminance from the first image with color information from the second image.

8. The method according to claim 6, further comprising applying a low pass filter to the first image and comparing the first image to the second image to identify the aliasing artifacts.

9. The method according to claim 6, further comprising generating a template of the aliasing artifacts.

10. The method according to claim 9, further comprising replacing portions of the first image with portions of the second image in response to the template.

11. The method according to claim 9, further comprising calculating values for the output image, in areas corresponding to the template, based on values for the first image and values for the second image.

12. The method according to claim 6, further comprising correcting the second image geometrically with respect to the first image.

13. The method according to claim 6, further comprising registering the second image with respect to the first image.

14. The method according to claim 6, further comprising calculating an amount of optical parameter difference between the first image and the second image based on characteristics of the aliasing artifact.

15. A system for enhancing images, the system comprising:
a first sensor to capture a first image;
a second sensor to capture a second image, the first image having a higher optical density than the second image; and
a processor in communication with the first sensor to receive a first image, the processor being in communication with the second sensor to receive a second image, the processor being configured to combine the first image and the second image to generate an output image with reduced aliasing artifacts.

16. The system according to claim 15, wherein the first sensor has a higher resolution than the second sensor.

17. The system according to claim 16, wherein the first sensor has a greater number of pixels than the second sensor.

18. The system according to claim 16, wherein the first sensor has a smaller pixel size than the second sensor.

19. The system according to claim 15, further comprising
a first lens assembly in optical communication with the first sensor; and
a second lens assembly in optical communication with the second sensor, wherein the processor is in communication with the first lens assembly and the second lens assembly, the processor being configured to select different optical parameters for the first lens assembly relative to the second lens assembly.

20. The system according to claim 19, wherein the processor is configured to adjust the optical parameters second lens assembly in response to characteristics of the aliasing artifact.
